(19) United States
(12) Patent Application Publication
(10) Pub. No.: US 2020/0242187 A1
(43) Pub. Date: Jul. 30, 2020

(54) METHOD, DEVICE, AND APPARATUS FOR MONITORING INFORMATION SHIELDING, AND COMPUTER-READABLE MEDIUM

(71) Applicant: Baidu Online Network Technology (Beijing) Co., Ltd, Beijing (CN)

(72) Inventors: Qingfeng Meng, Beijing (CN); Gang Liu, Beijing (CN); Minliang Chen, Beijing (CN); Zeneng Zhao, Beijing (CN)

(73) Assignee: Baidu Online Network Technology (Beijing) Co., Ltd., Beijing (CN)

(21) Appl. No.: 16/774,804

(22) Filed: Jan. 28, 2020

(30) Foreign Application Priority Data
Jan. 29, 2019 (CN) 201910085700.8

(51) Int. Cl. G06F 16/958; G06F 16/957; G06F 11/34; H04L 12/26

(52) U.S. Cl. CPC G06F 16/986; G06F 16/9577; H04L 43/0817; G06F 11/3476; G06F 16/9574

(57) ABSTRACT

A method, device, and apparatus for monitoring information shielding, and computer-readable medium are provided. The method includes: embodying a monitoring plug-in into a web page in an inline manner; monitoring a shielding for information on the web page with the monitoring plug-in; and uploading a monitoring log to a server of the web page, in response to the shielding for the information on the web page being monitored. In the embodiment of the present application, whether the information on the web page is shielded can be monitored by embodying a monitoring plug-in into the web page in an inline manner, so as to monitor information shielding on the web page. Additionally, the problem of intercepting and loading the monitoring plug-in by the browser can be solved by embodying the monitoring plug-in in an inline manner, so that the monitoring can operate normally.

### CROSS-REFERENCE TO RELATED APPLICATION

This application claims priority to Chinese patent application No. 201910085700.8, filed on Jan. 29, 2019 and entitled “Method, Device, and Apparatus for Monitoring Information Shielding, and Computer-Readable Medium”, which is hereby incorporated by reference in its entirety.

### TECHNICAL FIELD

The present application relates to a field of internet technology, and in particular, to a method and device for monitoring information shielding, and a computer-readable storage medium.

### BACKGROUND

With the development of Internet, information plug-ins such as those for advertisements are currently embodied into web browsing to push the advertisements to users. Therefore, most of the current browsers provide a function to shield advertisement plug-ins on a web page.

However, information on the advertising should be obtained by the web server or the advertising merchant to determine whether the served advertisement is shielded.

### SUMMARY

A method and device for monitoring information shielding and a computer-readable storage medium are provided according to embodiments of the present application, so as to at least solve the above technical problems in the existing technology.

According to a first aspect, a method for monitoring information shielding is provided according to an embodiment of the present application, including:

embodying a monitoring plug-in into a web page in an inline manner;

monitoring a shielding for information on the web page with the monitoring plug-in; and

uploading a monitoring log to a server of the web page, in response to the shielding for the information on the web page being monitored.

In one implementation, the monitoring a shielding for information on the web page with the monitoring plug-in includes:

monitoring a current environment of the web page; and

determining whether the current environment conforms to an environment for loading the information; and if the current environment conforms to the environment for loading the information, determining that the information on the web page is shielded.

In one implementation, the monitoring a shielding for information on the web page with the monitoring plug-in includes:

monitoring a display size of the information on the web page; and

determining whether the display size is less than a preset threshold; and if the display size is less than a preset threshold, determining that the information on the web page is shielded.

In one implementation, the monitoring a shielding for information on the web page with the monitoring plug-in includes:

monitoring a display status of the information on the web page;

determining whether the display status of the information is a visible status on the web page; and

if the display status of the information is not the visible status, determining that the information on the web page is shielded.

In one implementation, the uploading a monitoring log to a server of the web page, in response to the shielding for the information on the web page being monitored includes:

determining whether a current network is available;

if the current network is available, uploading the monitoring log to the server; and

if the current network is unavailable, storing the monitoring log locally.

In one implementation, uploading a monitoring log to a server of the web page, in response to the shielding for the information on the web page being monitored includes:

determining whether preset information is shielded on the web page; and if the preset information is shielded, uploading the monitoring log to the server of the web page.

According to a second aspect, a device for monitoring information shielding is provided according to an embodiment of the present application, including:

an inline module configured to embody a monitoring plug-in into a web page in an inline manner;

a monitoring module configured to a shielding for information on the web page with the monitoring plug-in; and

an uploading module configured to upload a monitoring log to a server of the web page, in response to the shielding for the information on the web page being monitored.

In one implementation, the monitoring module comprises an environment monitoring sub-module configured to:

monitor a current environment of the web page; and determine whether the current environment conforms to an environment for loading the information; and if the current environment conforms to the environment for loading the information, determine that the information on the web page is shielded.

In one implementation, the monitoring module comprises a display size monitoring sub-module configured to:

monitor a display size of the information on the web page; and determine whether the display size is less than a preset threshold; and if the display size is less than a preset threshold, determine that the information on the web page is shielded.

In one implementation, the monitoring module comprises a display status monitoring sub-module configured to:

monitor a display status of the information on the web page; determine whether the display status of the information is a visible status on the web page; and if the display status of the information is not the visible status, determine that the information on the web page is shielded.

In one implementation, the uploading module includes:

a determining sub-module configured to determine whether a current network is available;

an uploading sub-module configured to, if the current network is available, upload the monitoring log to the server; and

a storing sub-module configured to, if the current network is unavailable, store the monitoring log locally.

In one implementation, the uploading module includes:

a preset information determining sub-module configured to determine whether preset information is shielded on the web page; and if the preset information is shielded, upload the monitoring log to the server of the web page.

In a third aspect, an apparatus for monitoring information shielding is provided according to an embodiment of the present application, including:

one or more processors; and

a storage device configured for storing one or more programs, wherein

the one or more programs are executed by the one or more processors to enable the one or more processors to implement the above method for monitoring information shielding according to the first aspect.

In a possible embodiment, an apparatus for monitoring information shielding includes a processor and a storage device. The storage device is configured to store a program for supporting the above method for monitoring information shielding executed by the above apparatus for monitoring information shielding, and the processor is configured to execute the program stored in the storage device. The apparatus for monitoring information shielding further includes a communication interface configured for communication between the device and another apparatus or communication network.

In a fourth aspect, a computer-readable medium is provided for storing computer software instructions used by the above device for monitoring information shielding, the computer software instructions include programs involved in execution of the above method for monitoring information shielding according to the first aspect.

In one foregoing technical solution of the embodiment of the present application, whether the information on the web page is shielded can be monitored by embodying a monitoring plug-in into the web page in an inline manner, so as to monitor information shielding on the web page. In addition, the problem of intercepting and loading the monitoring plug-in by the browser can be solved by embodying the monitoring plug-in in an inline manner, so that the monitoring can operate normally.

In another solution of the embodiment of the present application, if logs need to be uploaded, multiple logs are stored locally and uploaded collectively, which can solve the problem that a user terminal suddenly fails to disconnect the network and the logs fail to be sent successfully.

The above summary is for the purpose of the specification only and is not intended to be limiting in any way. In addition to the illustrative aspects, embodiments, and features described above, further aspects, embodiments, and features of the present application will be readily understood by reference to the drawings and the following detailed description.

### BRIEF DESCRIPTION OF THE DRAWINGS

In the drawings, unless otherwise specified, identical reference numerals will be used throughout the drawings to refer to identical or similar parts or elements. The drawings are not necessarily drawn to scale. It should be understood that these drawings depict only some embodiments disclosed in accordance with the present application and are not to be considered as limiting the scope of the present application.

FIG. 1 is a flowchart of a method for monitoring information shielding according to an embodiment of the present application;

FIG. 2 is a flow chart of specific steps for monitoring environment in step S110 according to an embodiment of the present application;

FIG. 3 is a flow chart of specific steps for monitoring display size in step S110 according to an embodiment of the present application;

FIG. 4 is a flowchart of specific steps for monitoring information hiding in step S110 according to an embodiment of the present application;

FIG. 5 is a specific flowchart in step S120 according to an embodiment of the present application;

FIG. 6 is a flowchart of a specific application according to an embodiment of the present application;

FIG. 7 is a connection block diagram of a device for monitoring information shielding according to an embodiment of the present application;

FIG. 8 is an internal block diagram of a monitoring module according to an embodiment of the present application;

FIG. 9 is an internal block diagram of a uploading module according to an embodiment of the present application; and

FIG. 10 is a block diagram of an apparatus for monitoring information shielding according to another embodiment of the present application.

### DETAILED DESCRIPTION OF THE EMBODIMENTS

In the following, only certain exemplary embodiments are briefly described. As those skilled in the art would realize, the described embodiments may be modified in various different ways, all without departing from the spirit or scope of the present application. Accordingly, the drawings and description are to be regarded as illustrative in nature and not restrictive.

A method and a device for monitoring information shielding are provided according to embodiments of the present application. The specific processing flow and principle of the method and device for monitoring information shielding according to an embodiment of the present application will be described in detail below.

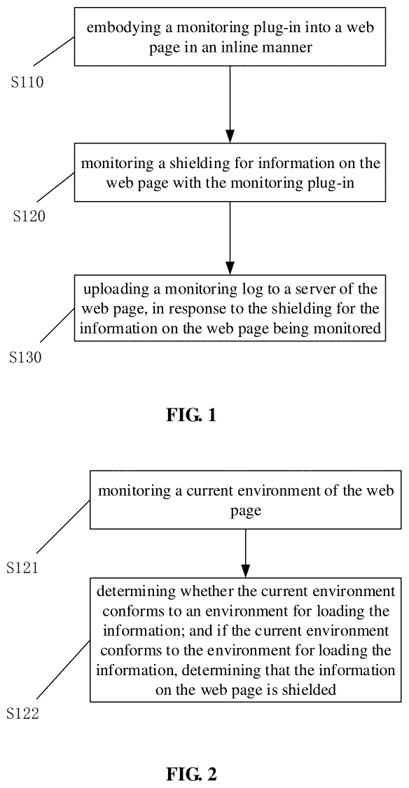

FIG. 1 is a flowchart of a method for monitoring information shielding according to an embodiment of the present application. In an embodiment, the method for monitoring information shielding according to an embodiment of the present application includes S110 to S130.

S110, embodying a monitoring plug-in into a web page in an inline manner.

In one implementation, the monitoring plug-in for monitoring information shielding can be programmed in a JS (JavaScript, Java Script) language. Then, the plug-in can be embodied into the web page in an inline manner and loaded synchronously with the web page, which prevents a the monitoring plug-in from being shielded by a browser as a general plug-in.

S120, monitoring a shielding for information on the web page with the monitoring plug-in.

In one implementation, the information on the web page may be a web page advertisement, or a specific publicity floating window, a headline, and the like. There are various ways to monitor a shielding status of an advertisement on the current web page, such as by monitoring the operating environment of the web page, a size of the advertisement, and a display status of the advertisement, and the like. As shown in FIG. 2, in one implementation, the step S110 may include S121 to S122.

S121, monitoring a current environment of the web page.

In one implementation, the current environment of the web page may be a current operating environment, which may include a current networking status, a network speed, an abnormality of a web page loading, an operating system of a current device, a data interface source limitation, a script interception restriction, and the like.

S122, determining whether the current environment conforms to an environment for loading the information; and if the current environment conforms to the environment for loading the information, determining that the information on the web page is shielded.

For example, in the case of an advertisement, after obtaining the current operating environment of the web page, it is determined whether a condition for loading the current advertisement can be satisfied. In a case that the condition is satisfied, the advertisement plug-in can be loaded and displayed on the web page. In a case that the condition is not satisfied, it is indicated that the advertisement plug-in cannot be loaded and displayed on the web page, and then it can be determined that the current advertisement is shielded.

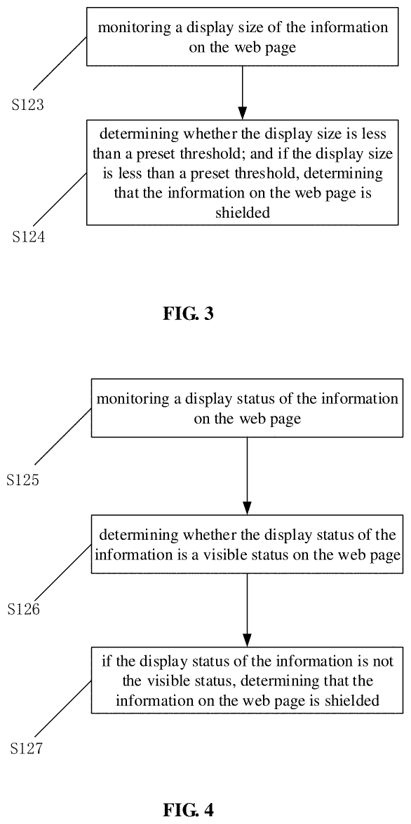

As shown in FIG. 3, in one implementation, in step S120, S123 to S124 may be further included when monitoring a shielding for information on the web page.

S123, monitoring a display size of the information on the web page.

In one implementation, for example, a display size of the advertisement on the current web page may be monitored. For example, a height and a width of the current advertisement may be obtained, and a size of the display area of the current advertisement on the web page may be obtained.

S124, determining whether the display size is less than a preset threshold; and if the display size is less than a preset threshold, determining that the information on the web page is shielded.

In one implementation, for example, it can be determined whether the height of the current advertisement size is set to 0, or is less than a preset threshold, for example, a value such as 0.001 mm which is relatively small to achieve a hidden effect.

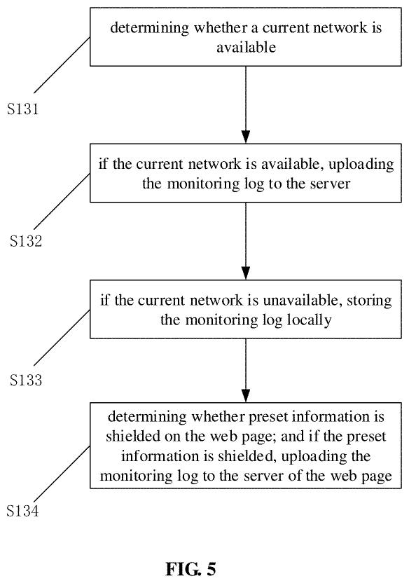

As shown in FIG. 4, in one implementation, in the step S110, S125 to S127 may be further included when monitoring a shielding for information on the web page.

S125, monitoring a display status of the information on the web page;

S126, determining whether the display status of the information is a visible status on the web page;

S127, if the display status of the information is not the visible status, determining that the information on the web page is shielded.

In one implementation, for example, it can be monitored whether the current advertisement can be displayed normally. Further, the current advertisement is likely to be loaded with a display parameter of the advertisement on the current web page being set to be hidden. In this case, the current advertisement cannot be displayed normally on the current page.

S130, uploading a monitoring log to a server of the web page, in response to the shielding for the information on the web page being monitored. The monitoring log may include the shielding for the information on the web page.

As shown in FIG. 5, in one implementation, in the step S130, S131 to S133 may be included when uploading a monitoring log to a server of the web page.

S131, determining whether a current network is available;

S132, if the current network is available, uploading the monitoring log to the server;

S133, if the current network is unavailable, storing the monitoring log locally.

In one implementation, before the monitoring log of the shielding for the information on the web page is uploaded, it may be determined whether the current network is available, so as to prevent losing the log during uploading. In a case that the current network is unavailable, for example, the current network speed is less than a preset value, the log can be stored locally. Then, after the network status reaches a preset condition, the locally stored monitoring logs can be uploaded together. The uploaded monitoring log may include: a browser type, a system type, a browser version, a network status, shielding means, a user ID and the like. The monitoring log facilitates to analyze compatibility of a particular device system according to monitoring data with different dimensions. After the log has been uploaded, an involved personnel on the server can use the uploaded data to analyze the current advertising, and whether an advertisement plug-in can be compatible with and loaded on different systems.

For example, in a case that a normal display ratio of the current advertisement is below a certain preset threshold, such as 30%, it indicates that the current advertising is undesirable. For another example, in a case that the normal display ratio of the current advertisement is higher than a certain preset threshold, such as 30%, it indicates that the current advertising is desirable.

In one implementation, step S130 may further include S134.

S134, determining whether preset information is shielded on the web page; and if the preset information is shielded, uploading the monitoring log to the server of the web page. The monitoring log here may include the shielding for the preset information on the web page For example, it can be monitored whether specific information on the current web page is shielded, such as a specific advertising, a promotion title, and so on.

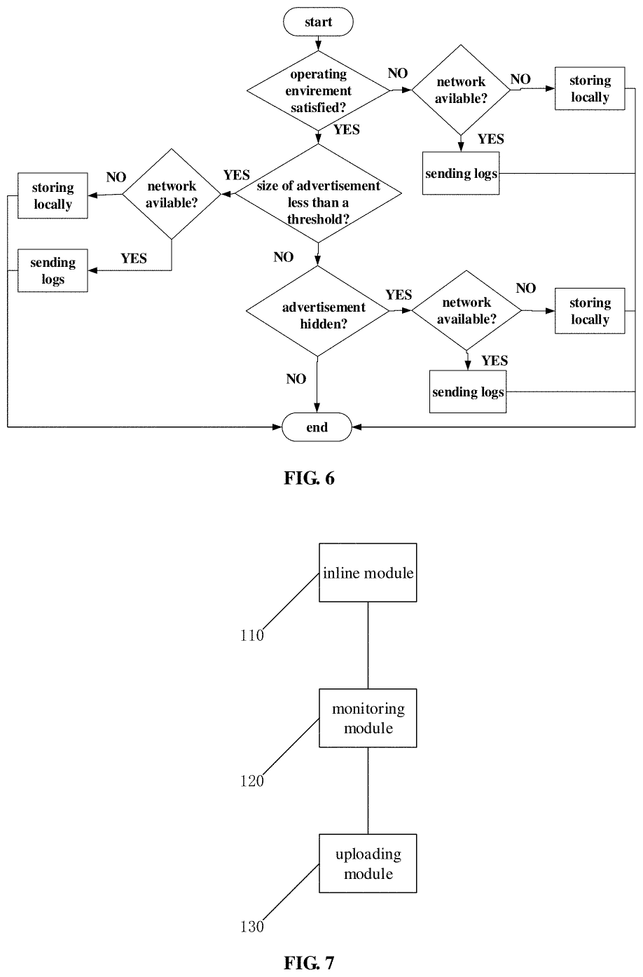

FIG. 6 illustrates a specific application flowchart of the method for monitoring information shielding according to an embodiment of the present application. In an embodiment, the operating environment of the advertisement, the size of the advertisement, and whether the advertisement is hidden may be sequentially determined, so as to determine whether the advertisement is shielded. When the user opens the web page, the monitoring plug-in on the web page starts to operate. Firstly, it is determined whether the operating environment of the current web page meets an operating condition of the current web page advertisement. In a case that the operating condition is not met, it is determined that the current advertisement is shielded. Then the current monitoring log is uploaded to the web page server. In a case that the operating condition is met, a next step is to be performed.

It is determined whether the current advertisement size is less than a preset threshold. In a case that the current advertisement size is less than the preset threshold, it is determined that the current advertisement is shielded, and the monitoring log is uploaded to the web page server. In a case that the current advertisement size is not less than the set threshold, a next step is to be performed.

It is determined whether the display status of the current advertisement is set to be a hidden status. In a case that the display state of the current advertisement is set to be the hidden status, it is determined that the current advertisement is shielded. The monitoring log is uploaded to the web page server. In a case that the display state of the current advertisement is not set to be the hidden status, the monitoring process of the current page is ended. When a user opens a new page, a similar monitoring operation is repeated.

In the embodiment of the present application, the information shielding in the web page can be monitored by embodying a plug-in for monitoring information shielding in the web page in an inline manner. In addition, the problem of intercepting and loading the plug-in by the browser can be solved by embodying in an inline manner, so that the monitoring can operate normally.

In addition, in the embodiment of the present application, if logs need to be uploaded, multiple logs are stored locally and uploaded collectively, which can solve the problem that a user terminal suddenly fails to disconnect the network and the logs fail to be sent successfully.

As shown in FIG. 7, a device for monitoring information shielding is provided according to another embodiment of the present application, includes:

an inline module 110 configured to embody a monitoring plug-in into a web page in an inline manner;

a monitoring module 120 configured to a shielding for information on the web page with the monitoring plug-in; and

an uploading module 130 configured to upload a monitoring log to a server of the web page, in response to the shielding for the information on the web page being monitored.

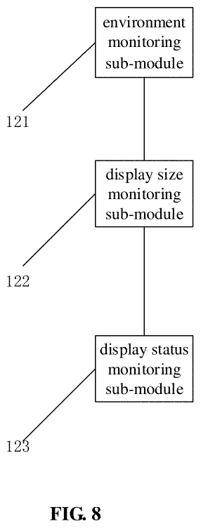

As shown in FIG. 8, the monitoring module 120 includes an environment monitoring sub-module 121 configured to:

monitor a current environment of the web page; and

determine whether the current environment conforms to an environment for loading the information; and if the current environment conforms to the environment for loading the information, determine that the information on the web page is shielded.

The monitoring module 120 includes a display size monitoring sub-module 122 configured to:

monitor a display size of the information on the web page; and

determine whether the display size is less than a preset threshold; and if the display size is less than a preset threshold, determine that the information on the web page is shielded.

The monitoring module 120 includes a display status monitoring sub-module 123, configured to:

monitor a display status of the information on the web page;

determine whether the display status of the information is a visible status on the web page; and

if the display status of the information is not the visible status, determine that the information on the web page is shielded.

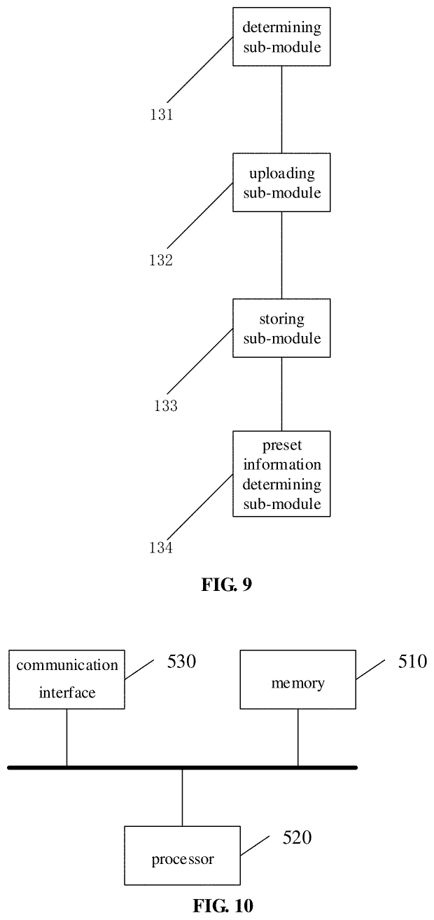

As shown in FIG. 9, the uploading module 130 includes:

a determining sub-module 131 configured to determine whether a current network is available;

an uploading sub-module 132 configured to, if the current network is available, upload the monitoring log to the server; and

a storing sub-module 133 configured to, if the current network is unavailable, store the monitoring log locally.

In one implementation, the uploading module 130 further includes a preset information determining sub-module 134 configured to determine whether preset information is shielded on the web page; and if the preset information is shielded, upload the monitoring log to the server of the web page.

In this embodiment, functions of modules in the device refer to the corresponding description of the above mentioned method and thus the description thereof is omitted herein.

As shown in FIG. 10, an apparatus for monitoring information shielding is provided according to another embodiment of the present application, including: a memory 510 and a processor 520. The memory 510 stores a computer program executable on the processor 520. When the processor 520 executes the computer program, the method in the foregoing embodiment is implemented. The number of the memory 510 and the processor 520 may be one or more.

The apparatus further includes:

a communication interface 530 configured to communicate with an external device and exchange data.

The memory 510 may include a high-speed RAM memory and may also include a non-volatile memory, such as at least one magnetic disk memory.

If the memory 510, the processor 520, and the communication interface 530 are implemented independently, the memory 510, the processor 520, and the communication interface 530 may be connected to each other through a bus and communicate with one another. The bus may be an Industry Standard Architecture (ISA) bus, a Peripheral Component (PCI) bus, an Extended Industry Standard Component (EISA) bus, or the like. The bus may be divided into an address bus, a data bus, a control bus, and the like. For ease of illustration, only one bold line is shown in FIG. 10, but it does not mean that there is only one bus or one type of bus.

Optionally, in a specific implementation, if the memory 510, the processor 520, and the communication interface 530 are integrated on one chip, the memory 510, the processor 520, and the communication interface 530 may implement mutual communication through an internal interface.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus.

The computer readable medium of the embodiments of the present application may be a computer readable signal medium or a computer readable storage medium or any combination of the above. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

In an embodiment of the present application, a computer readable signal medium may include a data signal propagating in a baseband or as part of a carrier, carrying computer readable program code. Such propagated data signals can take a variety of forms including, but not limited to, electromagnetic signals, optical signals, or any suitable combination of the above. The computer readable signal medium can also be any computer readable medium other than a computer readable storage medium, which can transmit, propagate, or transport a program for use in or in connection with an instruction execution system, an input method, or a device. Program code embodied on a computer readable medium can be transmitted by any suitable medium, including but not limited to wireless, wire, optical cable, radio frequency (RF), and the like, or any suitable combination of the above.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A method for monitoring information shielding, comprising:
embodying a monitoring plug-in into a web page in an inline manner;
monitoring a shielding for information on the web page with the monitoring plug-in; and
uploading a monitoring log to a server of the web page, in response to the shielding for the information on the web page being monitored.

2. The method according to claim 1, wherein the monitoring a shielding for information on the web page with the monitoring plug-in comprises:
monitoring a current environment of the web page; and
determining whether the current environment conforms to an environment for loading the information; and if the current environment conforms to the environment for loading the information, determining that the information on the web page is shielded.

3. The method according to claim 1, wherein the monitoring a shielding for information on the web page with the monitoring plug-in comprises:
monitoring a display size of the information on the web page; and
determining whether the display size is less than a preset threshold; and if the display size is less than a preset threshold, determining that the information on the web page is shielded.

4. The method according to claim 1, wherein the monitoring a shielding for information on the web page with the monitoring plug-in comprises:
monitoring a display status of the information on the web page;
determining whether the display status of the information is a visible status on the web page; and
if the display status of the information is not the visible status, determining that the information on the web page is shielded.

5. The method according to claim 1, wherein the uploading a monitoring log to a server of the web page, in response to the shielding for the information on the web page being monitored comprises:
determining whether a current network is available;
if the current network is available, uploading the monitoring log to the server; and
if the current network is unavailable, storing the monitoring log locally.

6. The method according to claim 1, wherein the uploading a monitoring log to a server of the web page, in response to the shielding for the information on the web page being monitored comprises:
determining whether preset information is shielded on the web page; and if the preset information is shielded, uploading the monitoring log to the server of the web page.

7. A device for monitoring information shielding, comprising:
one or more processors; and
a storage device configured for storing one or more programs, wherein the one or more programs are executed by the one or more processors to enable the one or more processors to:
embody a monitoring plug-in into a web page in an inline manner;
a shielding for information on the web page with the monitoring plug-in; and
upload a monitoring log to a server of the web page, in response to the shielding for the information on the web page being monitored.

8. The device according to claim 7, wherein the one or more programs are executed by the one or more processors to enable the one or more processors further to:
monitor a current environment of the web page; and
determine whether the current environment conforms to an environment for loading the information; and if the current environment conforms to the environment for loading the information, determine that the information on the web page is shielded.

9. The device according to claim 7, wherein the one or more programs are executed by the one or more processors to enable the one or more processors further to:
monitor a display size of the information on the web page; and
determine whether the display size is less than a preset threshold; and if the display size is less than a preset threshold, determine that the information on the web page is shielded.

10. The device according to claim 7, wherein the one or more programs are executed by the one or more processors to enable the one or more processors further to:
monitor a display status of the information on the web page;
determine whether the display status of the information is a visible status on the web page; and
if the display status of the information is not the visible status, determine that the information on the web page is shielded.

11. The device according to claim 7, wherein the one or more programs are executed by the one or more processors to enable the one or more processors further to:
a determining sub-module configured to determine whether a current network is available;
an uploading sub-module configured to, if the current network is available, upload the monitoring log to the server; and
a storing sub-module configured to, if the current network is unavailable, store the monitoring log locally.

12. The device according to claim 7, wherein the one or more programs are executed by the one or more processors to enable the one or more processors further to:
a preset information determining sub-module configured to determine whether preset information is shielded on the web page; and if the preset information is shielded, upload the monitoring log to the server of the web page.

13. A non-volatile computer-readable medium, storing a computer executable instructions stored thereon, that when executed by a processor cause the processor to perform operations comprising:
embodying a monitoring plug-in into a web page in an inline manner;
monitoring a shielding for information on the web page with the monitoring plug-in; and
uploading a monitoring log to a server of the web page, in response to the shielding for the information on the web page being monitored.

14. The non-volatile computer-readable storage medium of claim 13, wherein the computer executable instructions, when executed by a processor, cause the processor to perform further operations comprising:
monitoring a current environment of the web page; and
determining whether the current environment conforms to an environment for loading the information; and if the current environment conforms to the environment for loading the information, determining that the information on the web page is shielded.

15. The non-volatile computer-readable storage medium of claim 13, wherein the computer executable instructions, when executed by a processor, cause the processor to perform further operations comprising:
monitoring a display size of the information on the web page; and
determining whether the display size is less than a preset threshold; and if the display size is less than a preset threshold, determining that the information on the web page is shielded.

16. The non-volatile computer-readable storage medium of claim 13, wherein the computer executable instructions, when executed by a processor, cause the processor to perform further operations comprising:
monitoring a display status of the information on the web page;
determining whether the display status of the information is a visible status on the web page; and
if the display status of the information is not the visible status, determining that the information on the web page is shielded.

17. The non-volatile computer-readable storage medium of claim 13, wherein the computer executable instructions, when executed by a processor, cause the processor to perform further operations comprising:
determining whether a current network is available;
if the current network is available, uploading the monitoring log to the server; and
if the current network is unavailable, storing the monitoring log locally.

18. The non-volatile computer-readable storage medium of claim 13, wherein the computer executable instructions, when executed by a processor, cause the processor to perform further operations comprising:
determining whether preset information is shielded on the web page; and if the preset information is shielded, uploading the monitoring log to the server of the web page.
